(19) United States
(12) Patent Application Publication
(10) Pub. No.: US 2025/0292434 A1
(43) Pub. Date: Sep. 18, 2025

(54) ELECTRONIC DEVICE AND METHOD FOR COMPUTER VISION

(71) Applicant: SAMSUNG ELECTRONICS CO., LTD., Suwon-si (KR)

(72) Inventors: Hanlun LI, Beijing (CN); Zhihua LIU, Beijing (CN); Qiang WANG, Beijing (CN); SoonYong CHO, Suwon-si (KR)

(73) Assignee: SAMSUNG ELECTRONICS CO., LTD., Suwon-si (KR)

(21) Appl. No.: 19/079,204

(22) Filed: Mar. 13, 2025

(30) Foreign Application Priority Data
Mar. 13, 2024 (CN) 202410288936.2
Oct. 22, 2024 (KR) 10-2024-0144800

(51) Int. Cl. G06T 7/73; G06T 7/246

(52) U.S. Cl. CPC G06T 7/74; G06T 7/248; G06T 2207/10012; G06T 2207/20076; G06T 2207/30204; G06T 2207/30244

(57) ABSTRACT

An electronic device and method for computer vision are provided. The electronic device for computer vision includes a memory including instructions and a processor configured to execute the instructions, in which the instructions, when performed by the processor, cause the electronic device to determine a first position corresponding to a position of a landmark in a first image frame acquired at a first collection time prior to a second collection time in a second image frame acquired at the second collection time, determine uncertainty information corresponding to the first position based on the determined first position, determine the position of the landmark in the second image frame as a second position, and determine whether the landmark is an outlier based on the first position, the second position, and the uncertainty information.

### CROSS-REFERENCE TO RELATED APPLICATION

This application is based on and claims the benefit of priority under 35 USC ξ 119(a) from Chinese Patent Application No. 202410288936.2 filed on Mar. 13, 2024, in the China National Intellectual Property Administration, and Korean Patent Application No. 10-2024-0144800 filed on Oct. 22, 2024, in the Korean Intellectual Property Office, the entire disclosures of which are incorporated herein by reference for all purposes.

### BACKGROUND

### 1. Field

The disclosure relates to an electronic device for computer vision and a method executed by the electronic device.

### 2. Description of the Related Art

Simultaneous localization and mapping (SLAM) is an important technique in a computer vision field. SLAM is a technology that enables a machine (e.g., an autonomous vehicle or a robot) to perform localization and mapping in an unknown environment. Visual-inertial odometry (VIO) is a SLAM component, among SLAM components, that may determine a landmark to be removed by using input image data and sensor data acquired by an inertial sensor. SLAM may create precise trajectories and maps through the VIO process.

### SUMMARY

According to an aspect of the disclosure, there is provided an electronic device including: a memory including at least one instruction; and at least one processor configured to execute the at least one instruction, wherein, when executed by the at least one processor, the at least one instruction is configured to control the electronic device to: obtain a first position corresponding to a position of a landmark in a first image frame acquired at a first collection time prior to a second collection time in a second image frame acquired at the second collection time, obtain uncertainty information corresponding to the first position based on the first position, obtain a second position corresponding to the position of the landmark in the second image frame, and determine whether the landmark is an outlier based on the first position, the second position, and the uncertainty information.

The at least one instruction may be further configured to control the electronic device to: determine the uncertainty information based on reliability for the first position or an error range of the first position, wherein the first position includes first position information corresponding to the landmark in a two-dimensional coordinate system and second position information corresponding to the landmark in a three-dimensional coordinate system.

The electronic device may further include an image collection device, and the at least one instruction may be configured to control the electronic device to: obtain a first three-dimensional position corresponding to a three-dimensional position of the landmark in the first image frame and first uncertainty information corresponding to the first three-dimensional position, obtain pose information corresponding to a pose of the image collection device at the second collection time and second uncertainty information representing corresponding to the pose information, based on sensor data acquired from an inertial sensor during a time from the first collection time to the second collection time, obtain the second position corresponding to the position of the landmark in the second image frame, based on the first three-dimensional position and the pose information, and determine the uncertainty information corresponding to the first position based on the first position, the first three-dimensional position, the pose information, the first uncertainty information, and the second uncertainty information.

Based on the first position being a position corresponding to the landmark in the two-dimensional coordinate system, the at least one instruction, when executed by the at least one processor, may be further configured to control the electronic device to: obtain a projected position by projecting the landmark in the first image frame onto the second image frame, obtain third uncertainty information corresponding to the projected position based on the projected position, obtain a tracked position by tracking the landmark in the second image frame as the second position, and determine whether the landmark is an outlier based on the projected position, the tracked position, and the third uncertainty information.

The at least one instruction may be further configured to control the electronic device to: determine that the landmark is an outlier based on a difference between the projected position and the tracked position satisfying a first condition, and determine that the landmark is not an outlier based on the difference between the projected position and the tracked position not satisfying the first condition.

The first condition may include: the difference exceeding a threshold error range for the third uncertainty information or the difference being greater than a threshold value of the third uncertainty information.

Based on the first position being a position corresponding to the landmark in the three-dimensional coordinate system, the at least one instruction, when executed by the at least one processor, may be further configured to control the electronic device to: obtain a second three-dimensional position by converting a first three-dimensional position of the landmark in the first image frame into the three-dimensional coordinate system of the second image frame, obtain fourth uncertainty information corresponding the second three-dimensional position based on the second three-dimensional position, obtain a third three-dimensional position of the landmark in the second image frame, obtain fifth uncertainty information corresponding to the third three-dimensional position based on the third three-dimensional position, and determine whether the landmark is an outlier based on the second three-dimensional position, the third three-dimensional position, the fourth uncertainty information, and the fifth uncertainty information.

The at least one instruction may be further configured to control the electronic device to: obtain sixth uncertainty information based on the fourth uncertainty information and the fifth uncertainty information, determine that the landmark is an outlier based on a difference between the second three-dimensional position and the third three-dimensional position satisfying a second condition based on the sixth uncertainty information, and determine that the landmark is not an outlier based on the difference between the second three-dimensional position and the third three-dimensional position not satisfying the second condition.

The second condition may include: the difference exceeding a threshold error range for the sixth uncertainty information or the difference being greater than a threshold value of the sixth uncertainty information.

The electronic device may further include a binocular image collection device, and wherein the third three-dimensional position of the landmark in the second image frame is obtained based on the second image frame collected through the binocular image collection device at the second collection time.

The at least one instruction may be further configured to control the electronic device to: obtain a first result by determining whether the landmark is an outlier based on the first position, the second position, and the uncertainty information in the two-dimensional coordinate system, obtain a second result by determining whether the landmark is an outlier based on the first position, the second position, and the uncertainty information in the three-dimensional coordinate system, and determine that the landmark is an outlier based on the landmark being determined to be an outlier in at least one of the first result and the second result.

The electronic device may further include an image collection device, and wherein, when executed by the at least one processor, the at least one instruction may be further configured to control the electronic device to: obtain the position of the landmark in the second image frame as the second position, based on data collected by a binocular image collection device at the second collection time, or obtain the position of the landmark in the second image frame as the second position, based on data collected by the image collection device at the first collection time and the data collected by the image collection device at the second collection time.

The at least one instruction may be further configured to control the electronic device to: obtain map data; based on the map data including the landmark, determine the first three-dimensional position of the landmark included in the map data and determine the first uncertainty information based on the first three-dimensional position of the landmark included in the map data, or determine the first three-dimensional position corresponding to the three-dimensional position of the landmark in the first image frame and the first uncertainty information corresponding to the first three-dimensional position, based on data collected by a binocular image collection device at the first collection time.

The at least one instruction may be further configured to control the electronic device to: determine the pose information and the second uncertainty information at the second collection time by performing pre-integration based on at least one of a noise parameter of the output, an acceleration deviation of the previous BA optimization output, and the sensor data.

The electronic device may further include an image collection device, and wherein, when executed by the at least one processor, the at least one instruction may be further configured to control the electronic device to: based on the landmark being determined to be not an outlier based on the first position, the second position, and the uncertainty information, perform at least one among map reconstruction, the positioning of the electronic device, path planning, scene reconstruction, three-dimensional rendering, and three-dimensional reconstruction, based on the adjusting of a pose of the image collection device.

According to another aspect of the disclosure, there is provided a method executed by an electronic device, the method including: obtaining a first position corresponding to a position of a landmark in a first image frame acquired at a first collection time prior to a second collection time in a second image frame acquired at the second collection time; obtaining uncertainty information corresponding to the first position based on the first position; obtain a second position corresponding to the position of the landmark in the second image frame; and determining whether the landmark is an outlier based on the first position, the second position, and the uncertainty information.

The obtaining the uncertainty information may include: determining the uncertainty information based on reliability for the first position or an error range of the first position, wherein the first position includes first position information corresponding to the landmark in a two-dimensional coordinate system and second position information corresponding to the landmark in a three-dimensional coordinate system.

The determining the first position may include: obtaining a first three-dimensional position corresponding to a three-dimensional position of the landmark in the first image frame and first uncertainty information corresponding to the first three-dimensional position, obtaining pose information representing information corresponding to a pose of an image collection device at the second collection time and second uncertainty information corresponding to the pose information, based on sensor data acquired from an inertial sensor during a time from the first collection time to the second collection time; and obtaining the second position corresponding to the position of the landmark in the second image frame, based on the first three-dimensional position and the pose information, and wherein the uncertainty information corresponding to the first position is obtained based on the first position, the first three-dimensional position, the pose information, the first uncertainty information, and the second uncertainty information.

Based on the first position being a position corresponding to the landmark in the two-dimensional coordinate system, the determining the first position may include: obtaining a projected position by projecting the landmark in the first image frame onto the second image frame, the determining the uncertainty information may include: obtaining third uncertainty information corresponding to the projected position based on the projected position, the determining the second position may include: determining a tracked position by tracking the landmark in the second image frame, and the determining whether the landmark is an outlier may include: determining whether the landmark is an outlier based on the projected position, the tracked position, and the third uncertainty information.

Based on the first position being a position corresponding to the landmark in the three-dimensional coordinate system, the determining the first position may include: obtaining a second three-dimensional position by converting a first three-dimensional position of the landmark in the first image frame into the three-dimensional coordinate system of the second image frame, the determining the second position may include: obtaining a third three-dimensional position of the landmark in the second image frame, the determining the uncertainty information may include: obtaining fourth uncertainty information corresponding to the second three-dimensional position based on the second three-dimensional position, determining fifth uncertainty information based on the third three-dimensional position, and the determining whether the landmark is an outlier may include: determining whether the landmark is an outlier based on the second three-dimensional position, the third three-dimensional position, the fourth uncertainty, information and the fifth uncertainty information.

### BRIEF DESCRIPTION OF DRAWINGS

The above and other aspects, features, and advantages of some embodiments of the disclosure will be more apparent from the following description taken in conjunction with the accompanying drawings, in which:

FIG. 1 is a flowchart illustrating a method executed by an electronic device according to an embodiment.

FIG. 2 is a diagram illustrating a method of determining whether a landmark is an outlier in a two-dimensional coordinate system, according to an embodiment.

FIG. 3 is a diagram illustrating a method of determining whether a landmark of a dynamic object is an outlier, according to an embodiment.

FIG. 4 is a diagram illustrating a method of determining whether a landmark is an outlier in a three-dimensional coordinate system, according to an embodiment.

FIG. 5 is a block diagram illustrating a method of determining whether landmark is an outlier, according to an embodiment.

FIG. 6 is a diagram illustrating a method of generating a mask image of a dynamic object, according to an embodiment.

FIG. 7 is a diagram illustrating an electronic device according to an embodiment.

### DETAILED DESCRIPTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

Unless otherwise defined, all terms, including technical and scientific terms, used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Before the descriptions are provided with reference to the drawings, the technical terms used herein are defined as below:

Pose estimation: Pose estimation may refer to estimating the position and direction of a sensor. The sensor may include, but is not limited to, a camera or an inertial measurement sensor. For example, the sensors may vary depending on fields where the pose estimation is used. The pose estimation may be used in robot vision, motion tracking, single camera calibration, etc, but the disclosure is not limited thereto.

Inertial measurement unit (IMU): IMU may refer to a device that measures parameters including, but not limited to, the three-axis pose angle, angular velocity, and acceleration of a measurement target. The IMU may include three single-axis accelerometers and three single-axis gyroscopes. An accelerometer may detect a three-axis acceleration independent of a carrier coordinate system and a gyroscope may detect the angular velocity at which a carrier rotates with respect to a navigation coordinate system. The IMU may estimate the pose of the measurement target based on measuring the angular velocity and acceleration of the measurement target in a three-dimensional space.

Landmark: A landmark may refer to a specific point or a characteristic position in an image. The landmark may be a point in a three-dimensional space and may be used for simultaneous localization and mapping (SLAM).

Bundle adjustment (BA) optimization: BA optimization may refer to a nonlinear optimization technique that optimizes the position or direction of a camera, based on a plurality of images. The BA optimization may optimize a measurement deviation (e.g., a measurement deviation by an accelerometer or a measurement deviation by a gyroscope) by an IMU, the position of a landmark on a map, or the pose of a camera. The BA optimization may be used for SLAM.

Front-end tracking, front-end optimization, and back-end optimization: A SLAM system may include a front end and a back end. The front-end tracking may include operations of sensor data processing, feature extraction, pose estimation, and mapping. For example, data may be optimized through the front-end optimization. The back end may receive odometer information and loop detection information at different times and may generate a path and a map that maintain overall consistency based on the received odometer information and loop detection information. The back-end optimization may refer to improving the certainty of mapping and path optimization.

Jacobian matrix: A Jacobian matrix may refer to a matrix where first-order partial derivatives are arranged in a certain manner and its determinant is referred to as a Jacobian determinant. The Jacobian matrix may represent optimal linear approximation at a given point for a differentiable equation.

Hereinafter, embodiments are described in detail with reference to the accompanying drawings. When describing the embodiments with reference to the accompanying drawings, like reference numerals refer to like elements, and a repeated description related thereto is omitted.

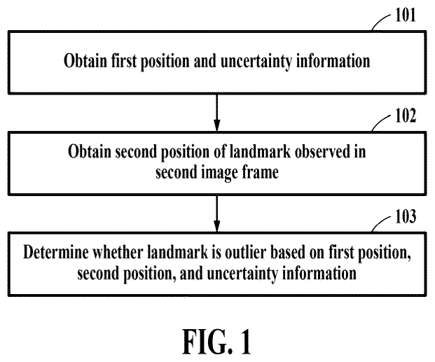

FIG. 1 is a flowchart illustrating a method executed by an electronic device according to an embodiment.

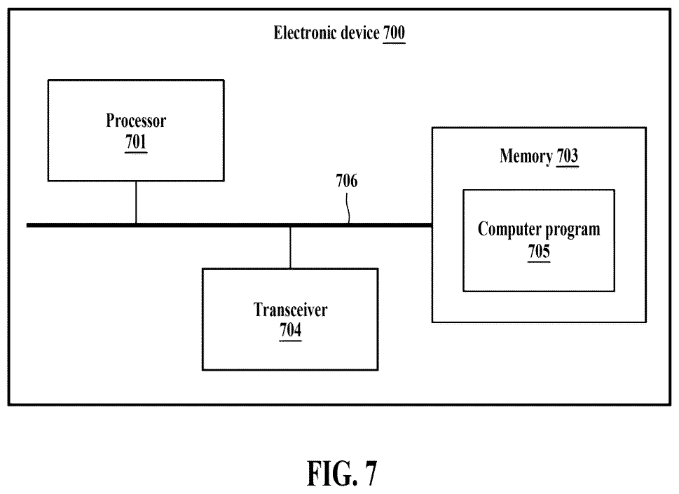

According to an embodiment, an electronic device (e.g., an electronic device 700 of FIG. 7) may determine whether a landmark in an image is an outlier by using a plurality of image frames and may remove the landmark that is an outlier.

Referring to FIG. 1, in operation 101, the method may include obtaining first position information corresponding to a landmark and uncertainty information based of the first position information. For example, the electronic device (e.g., the electronic device 700 of FIG. 7) may obtain a first position corresponding to the landmark and uncertainty based on the first position. For example, the electronic device may determine the first position corresponding to a position of the landmark in a first image frame acquired at a first collection time prior to a second collection time in a second image frame acquired at the second collection time. According to an embodiment, the landmark in the first image frame may be referred to as an observed landmark in the first image frame or identified landmark in the first image frame. The electronic device may determine, as the uncertainty information, the uncertainty corresponding to the first position based on the determined first position. The uncertainty information indicates a degree of uncertainty for the first position of the landmark in the first image frame at the first collection time in the second image frame acquired at the second collection time. For example, the uncertainty information indicates whether the first position of the landmark is reliable. For example, the uncertainty information may represent or indicate a degree of reliability of the first position of the landmark.

The first image frame and the second image frame may be two temporally consecutive image frames, or the first image frame and the second image frame may be sampled image frames from among all the image frames.

For example, an image frame may be an image frame used for binocular visual-inertial odometry (VIO), and the first image frame may include a left-eye first image frame and a right-eye first image frame. The second image frame may include a left-eye second image frame and a right-eye second image frame.

According to an embodiment, each landmark in the first image frame may be individually processed by the electronic device. According to an embodiment, some randomly selected landmarks in the first image frame may be individually processed by the electronic device. In an example case in which a number of landmarks determined as outliers after being individually processed by the electronic device exceeds a threshold landmark number, the electronic device may reselect a landmark in the first image frame. The reselected landmark may be reprocessed by the electronic device. The electronic device may process a landmark based on the random selection and repetitive processing as described above.

The determining the first position corresponding to a position of a landmark in the first image frame in the second image frame may refer to determining the first position by converting the position of the landmark in the first image frame into a coordinate system of the second image frame. The conversion of the position of the landmark in the first image frame into the coordinate system of the second image frame may include projection in a two-dimensional coordinate system and coordinate conversion in a three-dimensional coordinate system.

The uncertainty information representing the degree of uncertainty for the first position may be determined based on the error range or reliability of the first position. The uncertainty information may be determined based on a positional error that may be caused when determining the first position or a deviation that may occur at an actual position. For example, the uncertainty may be determined based on a noise of an IMU, a matching noise of front-end tracking, and/or an error of the first position of back-end optimization. The error of the first position of back-end optimization may include, but is not limited to, an error of the first position due to landmark coordinates, a camera pose, and/or a projected position. The uncertainty may be determined based on covariance, variance, and/or standard deviation.

The electronic device may determine the uncertainty information based on the error range of the first position and/or the reliability of the first position. The first position may include a position corresponding to the landmark in the two-dimensional coordinate system and a position corresponding to the landmark in the three-dimensional coordinate system. For example, the electronic device may determine a first three-dimensional position corresponding to a three-dimensional position of the landmark in the first image frame and first uncertainty information corresponding to the first three-dimensional position. According to an embodiment, in an example case in which the landmark is included in an acquired map data, the electronic device may determine the first three-dimensional position of the landmark in the map data and may determine the first uncertainty information corresponding to the first three-dimensional position. In an example case in which one landmark is tracked at a front end and is optimized at a back end, the first three-dimensional position of the landmark may be displayed on a map.

In an example case in which the acquired map data includes the landmark, the electronic device may determine the first three-dimensional position of the landmark included in the map data. The electronic device may determine the first uncertainty information based on the first three-dimensional position of the landmark included in the map data. According to another embodiment, regardless of whether the acquired map data includes the landmark or not, the electronic device may determine the first three-dimensional position corresponding to the three-dimensional position of the landmark in the first image frame and the first uncertainty information corresponding to the first three-dimensional position, based on data collected by a binocular image collection device at the first collection time.

The first three-dimensional position of the landmark may be determined through binocular stereo matching. In an example case in which b denotes a baseline, which is a distance between two viewpoints of both eyes, f denotes a focal distance, p(x,y) are pixel coordinates, and d denotes parallax, a first three-dimensional position P(X, Y, Z) of a landmark may be determined through Equation 1 below.

$$X = \frac{Z}{f} x , Y = \frac{Z}{f} y , Z = \frac{bf}{d} \qquad [ Equation 1 ]$$

The first uncertainty information corresponding to the first three-dimensional position of the landmark may be determined through the variance-covariance propagation law of a nonlinear function. In an example case in which the uncertainty of stereo matching is Dₓ, D_{y} and D_{d}, and D_{d}=Dₓ/\sqrt{2}, first uncertainty Dₓ, D_{y}, and D_{z} corresponding to the first three-dimensional position P of the landmark may be determined through Equations 2 to 4 below.

$${D}_{Z} = \frac{\partial Z}{\partial d} {D}_{d} = \frac{{Z}^{2}}{\sqrt{2} bf} {D}_{x} \qquad [ Equation 2 ]$$

$${D}_{X} = \sqrt{{( \frac{\partial X}{\partial Z} {D}_{z} )}^{2} + {( \frac{\partial X}{\partial x} {D}_{x} )}^{2}} = \frac{Z}{f} \sqrt{1 + {( \frac{{xZD}_{x}}{\sqrt{2} fb} )}^{2}} \qquad [ Equation 3 ]$$

$${D}_{Y} = \sqrt{{( \frac{\partial Y}{\partial Z} {D}_{z} )}^{2} + {( \frac{\partial Y}{\partial y} {D}_{y} )}^{2}} = \frac{Z}{f} \sqrt{1 + {( \frac{{yZD}_{y}}{\sqrt{2} fb} )}^{2}} \qquad [ Equation 4 ]$$

As shown in Equations 2 to 4, the first uncertainty information may be determined based on depth and pixel position.

The electronic device may determine pose data representing information on the pose of an image collection device at the second collection time and second uncertainty information representing uncertainty of the pose data, based on sensor data acquired from an inertial sensor during a time from the first collection time to the second collection time.

The image collection device (e.g., a camera) may collect a first image frame Iᵢ and a second image frame Iᵢ₊₁. The pose data of the image collection device may be expressed by ξ. ξ may have six degrees of freedom expressed by φ₁, φ₂, φ₃, t₁, t₂, and t₃. φ₁, φ₂, and φ₃ may be rotation information, and t₁, t₂, and t₃ may be parallel translation information.

The second uncertainty information may be determined during the pre-integration of an IMU, and the second uncertainty information may be expressed by D(φ₀), D(φ₁), D(φ₂), D(t₁), D(t₂), and D(t₃). The second uncertainty information may be determined based on an incremental, consistent, and efficient BA (ICEBA) framework for visual-inertial SLAM other than the pre-integration of the IMU, but examples are not limited thereto.

According to an embodiment, the electronic device may determine the pose data and the second uncertainty information at the second collection time by performing pre-integration. For example, the pre-integration may be performed based on at least one among a noise parameter of the inertial sensor, the gyroscope deviation of a previous BA optimization output, the acceleration deviation of the previous BA optimization output, and the sensor data. For example, the electronic device may estimate the pose of the image collection device at a time when the second image frame is collected and the second uncertainty information based on at least one among a noise parameter of the inertial sensor, the gyroscope deviation of the previous BA optimization output, the acceleration deviation of the previous BA optimization output, and a sensor data record of the inertial sensor. The electronic device may determine a projected position and uncertainty by converting the information of the landmark (e.g., the position of the landmark) in the first image frame into the coordinate system of the second image frame. The electronic device may determine whether the landmark is an outlier by comparing a tracked position, the projected position and the uncertainty.

In an example case in which the landmark is identified from both the left and right eyes of the second image frame, the electronic device may directly calculate the three-dimensional position of the landmark and the uncertainty corresponding to the three-dimensional position of the landmark. For example, whether the landmark is an outlier may be determined by comparing the converted three-dimensional position of the landmark, based on the three-dimensional position of the landmark and its uncertainty and a previous image frame.

In an example case in which the landmark is determined to be not an outlier, the pose of the image collection device may be optimized based on the landmark, and the performance accuracy of the electronic device may be improved through BA optimization.

The electronic device may determine the first position corresponding to the position of the landmark identified in the first image frame in the second image frame, based on the first three-dimensional position and the pose data. In an example case in which the first position determined in the second image frame is based on the two-dimensional position, the electronic device may determine a first two-dimensional position (e.g., a projected position) at which the landmark in the first image frame is identified in the second image frame, based on the pose of the image collection device at a time when the first three-dimensional position and the second image frame are collected. In an example case in which the first position determined in the second image frame is based on the three-dimensional position, the electronic device may determine the first three-dimensional position (e.g., a position by coordinate conversion) at which the landmark in the first image frame is identified in the second image frame, based on the pose data of the image collection device at a time when the first three-dimensional position and the second image frame are collected.

The electronic device may determine uncertainty information corresponding to the first position based on the first position, the first three-dimensional position, the pose data, the first uncertainty information, and the second uncertainty information. For example, the electronic device may determine the uncertainty information corresponding to the first position by converting the first three-dimensional position, the pose data, the first uncertainty information, and the second uncertainty information into the coordinate system of the second image frame. The electronic device may determine whether the landmark is an outlier by comparing the first position, the second position, and the uncertainty information.

According to an embodiment, the electronic device may reduce the computational amount of VIO and may support real-time processing compared to a method using a deep-learning model. The electronic device may remove various types of outliers. According to embodiments of the disclosure, the types of dynamic objects are not limited. According to an embodiment, the electronic device may be used reduce the computational amount of VIO in an example case in which dynamic objects occupy a certain portion (or percentage) of the image. For example, According to an embodiment, the electronic device may be used in an example case in which dynamic objects occupy most of the image. However, the disclosure is not limited thereto and as such, the electronic device according to various example embodiments of the disclosure may be used in other scenarios.

According to an embodiment, the electronic device may be used in an example case in which the landmark is a position of a two-dimensional coordinate system. In an example case in which the landmark is a position of the two-dimensional coordinate system, a first position in two dimensions may be a projected position, and a second position in two dimensions may be a tracked position. For example, the electronic device may determine the projected position at which the landmark in the first image frame is projected onto the second image frame and may determine third uncertainty information based on the projected position. The third uncertainty information may represent the uncertainty or the reliability of the projected position.

The projected position may be determined through the following process. A projected position \hat{p}ᵢ₊₁ of a landmark P may be determined based on a first three-dimensional position \hat{P}ᵢ of the landmark P of a first image frame Iᵢ and pose data ξ of a second image frame Iᵢ₊₁. The first three-dimensional position of the landmark P of the first image frame Iᵢ may be determined based on Equation 1, and the description of the pose data ξ of the second image frame Iᵢ₊₁ is provided above, and thus, the repeated description is omitted.

The projected position may be determined through Equation 5 below.

$${\hat{p}}_{i + 1} = π ( exp ( ξ \hat{} ) {\hat{P}}_{i} ) \qquad [ Equation 5 ]$$

In Equation 5, \hat{ } denotes an antisymmetric conversion symbol and exp(ξ\hat{ }) denotes a pose vector of pose data being converted in a matrix format.

According to an embodiment, third uncertainty D(\hat{p}ᵢ₊₁) may be determined based on the first three-dimensional position \hat{P}ᵢ of the landmark P of the first image frame Iᵢ and first uncertainty D(\hat{X}ᵢ), D(Ŷᵢ), and D(\hat{Z}ᵢ) corresponding to the first three-dimensional position \hat{P}ᵢ, the pose data ξ of the second image frame Iᵢ₊₁ and the second uncertainty D(φ₀), D(φ₁), D(φ₂), D(t₁), D(t₂), and D(t₃) corresponding to the pose data ξ, and the projected position \hat{p}ᵢ₊₁. The description of the first three-dimensional position \hat{P}ᵢ of the landmark P of the first image frame Iᵢ and the first uncertainty D(\hat{X}ᵢ), D(Ŷᵢ), and D(\hat{Z}₁) the first three-dimensional position \hat{P}ᵢ and the pose data ξ of the second image frame Iᵢ₊₁ and the second uncertainty D(φ₀), D(φ₁), D(φ₂), D(t₁), D(t₂), and D(t₃) corresponding to the pose data ξ is provided above, and thus, the repeated description is omitted. The third uncertainty information may be determined through Equation 6 below.

$$D ( {\hat{p}}_{i + 1} ) = \sqrt{diag ( S ( {\hat{P}}_{i + 1} ) )} \qquad [ Equation 6 ]$$

In Equation 6, diag represents forming a vector by taking a diagonal element, and S(\hat{P}ᵢ₊₁) may be determined through Equation 7 below.

$$S ( {\hat{P}}_{i + 1} ) = J ( ξ , {\hat{P}}_{i} ) S ( ξ , {\hat{P}}_{i} ) {J ( ξ , {\hat{P}}_{i} )}^{T} \qquad [ Equation 7 ]$$

In Equation 7, S(ξ, \hat{P}ᵢ) is a 9×9 diagonal matrix, and the elements of the diagonal matrix includes D(φ₀)², D(φ₁)², D(φ₂)², D(t₀)², D(t₁)², D(t₂)², D(\hat{X}ᵢ)², D(Ŷᵢ)², and D(\hat{Z}ᵢ)² based on the first uncertainty information and the second uncertainty information. An off-diagonal element is 0 in the diagonal matrix S(ξ, \hat{P}ᵢ).

In Equation 7, J(ξ, \hat{P}ᵢ) is a 2×9 diagonal matrix. J(ξ) in six columns before J(ξ, \hat{P}ᵢ) may be a Jacobian matrix for the pose data ξ of the projected position \hat{p}ᵢ₊₁ and may be expressed by Equation 8 below.

$$( ξ ) = - [ \begin{matrix}\frac{{f}_{x}}{{\hat{Z}}_{i}} & 0 & \frac{{f}_{x} {\hat{X}}_{i}}{{\hat{Z}}_{i}^{2}} & - \frac{{f}_{x} {\hat{X}}_{i} {\hat{Y}}_{i}}{{\hat{Z}}_{i}^{2}} & {f}_{x} + \frac{{f}_{x} {\hat{X}}_{i}^{2}}{{\hat{Z}}_{i}^{2}} & - \frac{{f}_{x} {\hat{Y}}_{i}}{{\hat{Z}}_{i}} \\ 0 & \frac{{f}_{y}}{{\hat{Z}}_{i}} & - \frac{{f}_{y} {\hat{Y}}_{i}}{{\hat{Z}}_{i}^{2}} & - {f}_{y} - \frac{{f}_{y} {\hat{Y}}_{i}^{2}}{{\hat{Z}}_{i}^{2}} & \frac{{f}_{y} {\hat{X}}_{i} {\hat{Y}}_{i}}{{\hat{Z}}_{i}^{2}} & \frac{{f}_{y} {\hat{X}}_{i}}{{\hat{Z}}_{i}}\end{matrix} ] \qquad [ Equation 8 ]$$

In Equation 8, J(\hat{P}ᵢ) in three columns after J(ξ, \hat{P}ᵢ) may be a Jacobian matrix for the first three-dimensional position \hat{P}ᵢ of the projected position \hat{p}ᵢ₊₁ and may be expressed by Equation 9 below.

$$J ( {\hat{P}}_{i} ) = - [ \begin{matrix}\frac{{f}_{x}}{{\hat{Z}}_{i}} & 0 & \frac{{f}_{x} {\hat{X}}_{i}}{{\hat{Z}}_{i}^{2}} \\ 0 & \frac{{f}_{y}}{{\hat{Z}}_{i}} & - \frac{{f}_{y} {\hat{Y}}_{i}}{{\hat{Z}}_{i}^{2}}\end{matrix} ] exp ( φ \hat{} ) \qquad [ Equation 9 ]$$

The determining of a second position (e.g., a tracked position) in two dimensions is described in more detail in operation 102.

According to an embodiment, in operation 102, the method may include obtaining a second position of an observer landmark in a second image frame. For example, the electronic device may determine the second position of the landmark identified in the second image frame.

The electronic device may determine the position of the landmark identified in the second image frame as the second position. The position of the landmark identified in the second image frame may be a landmark observed at a time when the second image frame is collected after the landmark is moved in the first image frame. The second position may include a position predicted by the electronic device or a position detected in real time, but examples are not limited thereto. The second position may be used as a reference position or may be used to determine whether the landmark is an outlier. If the first position is two-dimensional coordinates, the second position is also two-dimensional coordinates, and, if the first position is three-dimensional coordinates, the second position is also three-dimensional coordinates.

If the landmark is a position of the two-dimensional coordinate system, the second position may be a tracked position acquired by tracking the landmark in the second image frame. The electronic device may determine the position of the landmark identified in the second image frame as the second position, based on data collected by the binocular image collection device at the second collection time. According to an embodiment, the electronic device may determine the second position based on data collected by the image collection device at the first collection time and the data collected by the image collection device at the second collection time. The image collection device may include, but is not limited to, a binocular image collection device or a monocular image collection device. For example, the binocular image collection device may be a binocular camera and the monocular image collection device may be a monocular camera. For example, in an example case in which the tracked position of the landmark P of the first image frame Iᵢ is pᵢ₊₁ in the second image frame Iᵢ₊₁, the tracked position may be a position acquired by predicting the landmark observed in the first image frame Iᵢ in the second image frame Iᵢ₊₁ based on the two image frames.

The tracked position may be determined through an optical flow method. An optical flow may be generated through the movement of an object in a scene, the movement of a camera, or a combination thereof. The optical flow method may be a method of calculating the movement information of an object between image frames by finding out a corresponding relationship between the first image frame Iᵢ and the second image frame Iᵢ₊₁, based on a correlation between adjacent image frames and a temporal change of pixels in the adjacent image frames. A tracked position pᵢ₊₁ may be determined through a neural network, but examples are not limited thereto.

According to an embodiment, in operation 103, the method may include determining whether the landmark is an outlier. For example, the electronic device may determine whether the landmark is an outlier based on the first position determined in operation 101 and the uncertainty of the first position and the second position determined in operation 102.

The electronic device may determine that the landmark is an outlier based on the difference between the projected position acquired by projecting the landmark observed in the first image frame onto the second image frame and the tracked position acquired by tracking the landmark in the second image frame satisfying a first condition. The electronic device determine that the landmark is not an outlier if the difference does not satisfy the first condition.

The electronic device may determine whether the landmark is an outlier based on the projected position, the tracked position and the third uncertainty information. In an example case in which the landmark is a position of the two-dimensional coordinate system, the first position may be the projected position, and the second position may be the tracked position. Based on the difference between the projected position \hat{p}ᵢ₊₁ and the tracked position pᵢ₊₁ satisfying the first condition related to the third uncertainty D(\hat{p}ᵢ₊₁) representing uncertainty (or reliability) of the projected position, the landmark P may be determined to be an outlier. The first condition may include the difference exceeding a threshold error range for the third inaccuracy or being greater than a threshold value of the third inaccuracy. For example, the difference between the projected position \hat{p}ᵢ₊₁ and the tracked position pᵢ₊₁ is greater than a threshold value of a value |D(\hat{p}ᵢ₊₁)| acquired by converting the third uncertainty information into one dimension, the landmark may be determined to be an outlier. Whether the landmark is an outlier may be determined based on an inequation expressed by Equation 10 below.

$$\vert {\hat{p}}_{i + 1} - {p}_{i + 1} \vert ≫ \vert D ( {\hat{p}}_{i + 1} ) \vert \qquad [ Equation 10 ]$$

In an example case in which the inequation is satisfied, the landmark P may be determined to be not an outlier, and, if unsatisfied, the landmark P may be determined to be an outlier.

The landmark may be a landmark in a static image or a dynamic image. An image may include at least one dynamic object. The electronic device does not specifically limit the range of dynamic objects. The outlier refers to data inappropriate for a scene, may be referred to as an outer point, a noise point, or the like, and may include a feature point of a dynamic object. A point that is opposite to the outlier may be referred to as an inner point or a correct sample. The point that is opposite to the outlier may refer to data appropriate for the scene.

According to an embodiment, the electronic device may individually determine whether a landmark included in an image is an outlier without determining whether the landmark is an outlier in a relationship between landmarks included in the image. In other words, the electronic device does not determine whether the landmark is an outlier based on the entire (or the whole) image. Since a feature of the electronic device includes individually determining whether the landmark included in the image is an outlier, the electronic device may be used in an example case in which dynamic objects occupy most of the image, improving the real-time performance and stability of VIO.

The electronic device may acquire a first result by determining whether the landmark is an outlier based on the first position, the second position, and the uncertainty in the two-dimensional coordinate system and may acquire a second result by determining whether the landmark is an outlier based on the first position, the second position, and the uncertainty in the three-dimensional coordinate system. The electronic device may determine that the landmark is an outlier if the landmark is determined to be an outlier in at least one between the first result and the second result. The electronic device may determine whether the landmark is an outlier based on the two-dimensional coordinate system and the three-dimensional coordinate system, and, based on the landmark being determined to be an outlier in either coordinate system, the landmark may be determined to be an outlier. The electronic device may determine whether the landmark is an outlier based on the two-dimensional coordinate system and the three-dimensional coordinate system and may apply a weight to each coordinate system.

The electronic device may remove an outlier from an image including a dynamic image. The electronic device may be suitable for an image having mostly dynamic objects, and thus, the real-time performance and stability of VIO may be improved.

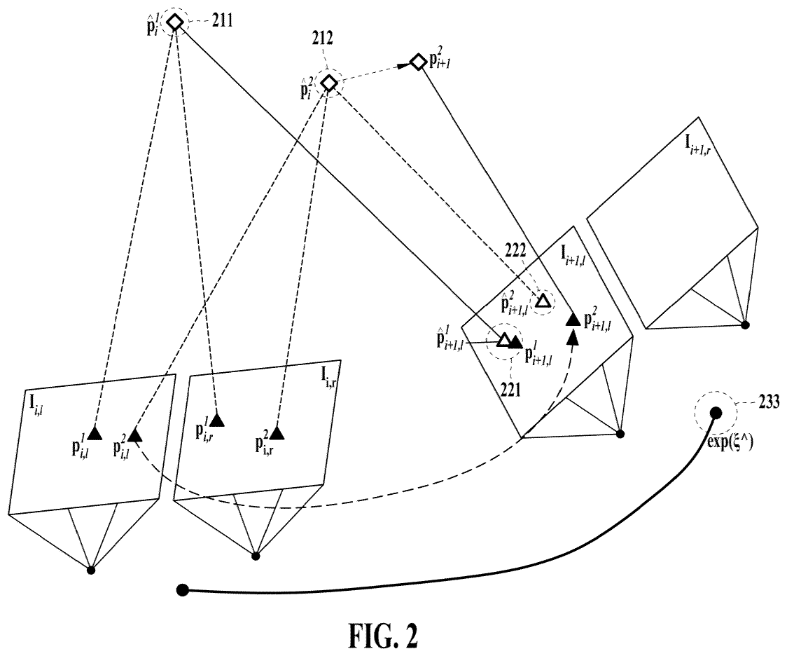

FIG. 2 is a diagram illustrating a method of determining whether a landmark is an outlier in a two-dimensional coordinate system, according to an embodiment.

Referring to FIG. 2, two landmarks may be observed in a first image frame Iᵢ. Pᵢ¹ (including p_{i,l}¹ and p_{i,r}¹ of both eyes) may be a position corresponding to a landmark in the background, and Pᵢ² (including p_{i,l}² and p_{i,r}² of both eyes) may be a position corresponding to a landmark on a dynamic object.

The first three-dimensional positions of the landmarks Pᵢ¹ and Pᵢ² are \hat{P}ᵢ¹ and \hat{P}ᵢ². The electronic device may determine first uncertainty information for each first three-dimensional position. First uncertainty areas 211 and 212 may be areas corresponding to the first uncertainty information. The projected positions of the landmarks Pᵢ¹ and \hat{P}ᵢ² of a second image frame Iᵢ₊₁ may be \hat{p}ᵢ₊₁¹ (including \hat{p}_{i+1,l}¹ and \hat{p}_{i+1,r}¹) and \hat{p}ᵢ₊₁² (including \hat{p}_{i+1,l}² and \hat{p}_{i+1,r}²), respectively. The electronic device may determine third uncertainty information for each of the projected positions. Third uncertainty areas 221 and 222 may be areas corresponding to the third uncertainty information. The movement of a dynamic object cause the position of the landmark Pᵢ² to be changed to Pᵢ₊₁², a three-dimensional position corresponding to Pᵢ₊₁² is \hat{P}ᵢ₊₁², and the three-dimensional position of the landmark Pᵢ¹ is not changed (or changed within a reference amount). The electronic device may determine second uncertainty information and pose data ξ in the second image frame Iᵢ₊₁. A second uncertainty area 233 may be an area corresponding to the second uncertainty information. A tracked position corresponding to \hat{P}ᵢ₊₁¹ is pᵢ₊₁¹ (including p_{i+1,l}¹ and p_{i+1,r}¹), and a tracked position corresponding to \hat{P}ᵢ₊₁² is pᵢ₊₁² (including p_{i+1,l}² and p_{i+1,r}²). The electronic device may determine whether a landmark is an outlier based on the information above. Since landmark Pᵢ² is moved, the tracked position pᵢ₊₁² is far away from the projected position \hat{p}ᵢ₊₁², and, the tracked position pᵢ₊₁² may be considered an outlier since it is not included in the third uncertainty area 222 corresponding to the projected position \hat{p}ᵢ₊₁². landmark Pᵢ¹ may not be determined to be an outlier since the tracked position pᵢ₊₁¹ is included in the third uncertainty area 221 corresponding to the projected position \hat{p}ᵢ₊₁¹.

The electronic device may individually determine whether each landmark is an outlier in a two-dimensional coordinate system. For example, the electronic device may determine whether a landmark is an outlier based on the magnitude of uncertainty and the positional relationship of the landmark. Since the electronic device determines whether a landmark is an outlier not from the perspectives of the whole image, the electronic device may be able to provide accurate real-time processing of the landmarks even when dynamic objects occupy most of the image. Therefore, the electronic device may improve the real-time performance and stability of VIO.

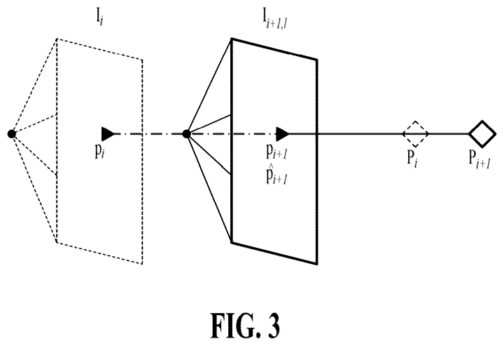

FIG. 3 is a diagram illustrating a method of determining whether a landmark of a dynamic object is an outlier, according to an embodiment.

Referring to FIG. 3, the moving direction of a dynamic object may be the same as or similar to the moving direction of a camera. In an example case in which the moving direction of the dynamic object is the same as or similar to the moving direction of the camera, a method of determining whether a landmark is an outlier based on a three-dimensional coordinate system may be efficient.

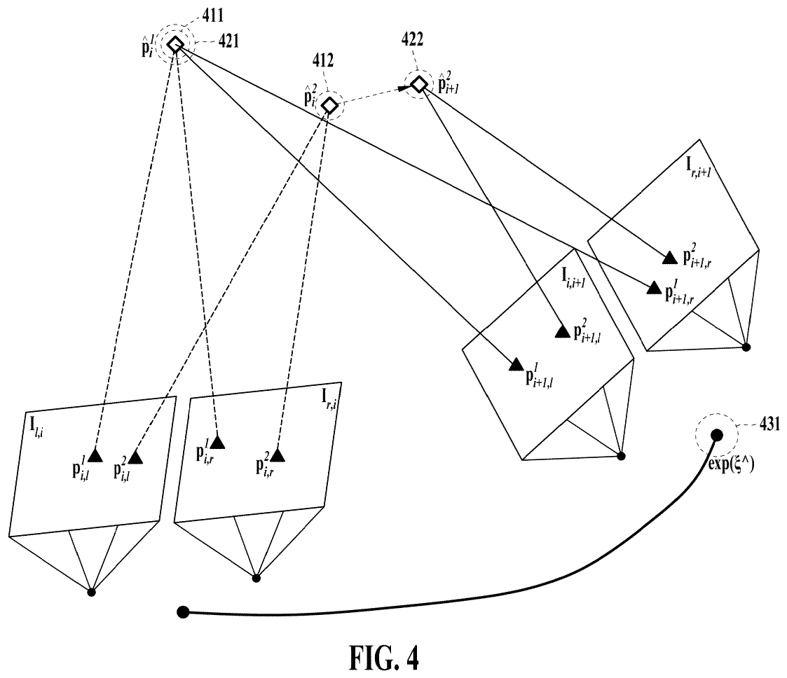

For example, as illustrated in FIG. 3, in an example case in which a position Pᵢ of a landmark P of a dynamic object is moved to a position Pᵢ₊₁, the observed position of Pᵢ in a first image frame Iᵢ is pᵢ, and the observed position of Pᵢ₊₁ in a second image frame Iᵢ₊₁ is Pᵢ₊₁. In an example case in which Pᵢ is projected onto the first image frame Iᵢ₊₁, a projected position \hat{p}ᵢ₊₁ may be the same as pᵢ₊₁. In this case, the electronic device may determine whether a landmark is an outlier based on the three-dimensional coordinate system. The electronic device determining whether the landmark is an outlier based on the three-dimensional coordinate system is described in more detail with reference to FIG. 4.

FIG. 4 is a diagram illustrating a method of determining whether a landmark is an outlier in a three-dimensional coordinate system, according to an embodiment.

Referring to FIG. 4, the electronic device may individually determine whether the landmark is an outlier in the three-dimensional coordinate system. In an example case in which a first position corresponds to a landmark in the three-dimensional coordinate system, the electronic device may determine a second three-dimensional position by converting a first three-dimensional position of a landmark observed in a first image frame into the three-dimensional coordinate system of a second image frame and may determine fourth uncertainty information based on the second three-dimensional position.

The electronic device may determine the second three-dimensional position of a landmark P by converting the position of the landmark P in the three-dimensional coordinate system of the first image frame into the three-dimensional coordinate system of a second image frame Iᵢ₊₁. The electronic device may determine Pᵢ₊₁′ based on a first three-dimensional position \hat{P}ᵢ of the landmark P of a first image frame Iᵢ and pose data ξ of the second image frame Iᵢ₊₁. The determining of the first three-dimensional position Pᵢ of the landmark P of the first image frame Iᵢ and the determining of the pose data ξ of the second image frame Iᵢ₊₁ may be described with reference to FIG. 1, and the repeated description is omitted.

Pᵢ₊₁′ may be determined by converting the first three-dimensional position \hat{P}ᵢ of the coordinate system of the first image frame Iᵢ into the coordinate system of the second image frame Iᵢ₊₁. Pᵢ₊₁′ may be determined through Equation 11 below.

$${P}_{i + 1}^{′} = exp ( ξ \hat{} ) {\hat{P}}_{i} \qquad [ Equation 11 ]$$

In Equation 11, \hat{ } denotes an antisymmetric conversion symbol, and exp(ξ\hat{ }) denotes a pose vector of pose data being converted in a matrix format.

The electronic device may determine fourth uncertainty D(Pᵢ₊₁′) corresponding to a second three-dimensional position Pᵢ₊₁′, based on the first three-dimensional position \hat{P}ᵢ of the first image frame Iᵢ and first uncertainty D(\hat{X}ᵢ), D(Ŷᵢ), and D(\hat{Z}ᵢ) corresponding to the first three-dimensional position \hat{P}ᵢ and the pose data ξ of the second image frame Iᵢ₊₁ and second uncertainty D(φ₀), D(φ₁), D(φ₂), D(t₁), D(t₂), and D(t₃) corresponding to the pose data ξ. The determining of the first three-dimensional position \hat{P}ᵢ of the landmark P of the first image frame Iᵢ and the first uncertainty D(\hat{X}ᵢ), D(Ŷᵢ), and D(\hat{Z}ᵢ) corresponding to the first three-dimensional position Pᵢ and the determining of the pose data ξ of the second image frame Iᵢ₊₁ and the second uncertainty D(φ₀), D(φ₁), D(φ₂), D(t₁), D(t₂), and D(t₃) corresponding to the pose data ξ may be described with reference to FIG. 1, the repeated description is omitted. Fourth uncertainty D(Pᵢ₊₁′) may be determined through Equation 12 below.

$$D ( {P}_{i + 1}^{′} ) = \sqrt{diag ( J ( ξ , {\hat{P}}_{i} ) S ( ξ , {\hat{P}}_{i} ) {J ( ξ , {\hat{P}}_{i} )}^{T} )} \qquad [ Equation 12 ]$$

In Equation 12, diag represents forming a vector by taking a diagonal element. S(ξ, \hat{P}ᵢ) is a 9×9 diagonal matrix, and diagonal elements are D(φ₀)², D(φ₁)², D(φ₂)², D(t₀)², D(t₁)², D(t₂)², D(\hat{X}ᵢ)², D(Ŷᵢ), and D(\hat{Z}ᵢ)² that are acquired based on the first uncertainty information and the second uncertainty information. An off-diagonal element of S(ξ, \hat{P}ᵢ) is 0.

According to an embodiment, J(ξ, \hat{P}ᵢ) is a 3×9 diagonal matrix, and J(ξ) and J(\hat{P}ᵢ) are the pose data ξ of the second three-dimensional position Pᵢ₊₁′ and a Jacobian matrix for the first three-dimensional position \hat{P}ᵢ, respectively. J(ξ) is a 3×6 matrix and J(\hat{P}ᵢ) is a 3×3 matrix. J(ξ) and J(\hat{P}ᵢ) may be determined through Equations 13 and 14 below.

$$J ( ξ ) = \frac{\partial ( {P}_{i + 1}^{′} )}{\partial ( ξ )} = [ I , {P}_{i + 1}^{′ \hat{}} ] \qquad [ Equation 13 ]$$

$$J ( {\hat{P}}_{i} ) = \frac{\partial ( {P}_{i + 1}^{′} )}{\partial ( {\hat{P}}_{i} )} = exp [ φ \hat{} ] \qquad [ Equation 14 ]$$

In Equations 13 and 14, \hat{ } denotes an antisymmetric conversion symbol and exp(φ\hat{ }) denotes a rotation vector being converted in a matrix format.

The electronic device may determine a third three-dimensional position of the landmark observed in the second image frame and may determine fifth uncertainty information based on the third three-dimensional position.

The image collection device may include a binocular image collection device. A binocular image collection device may be used to acquire a left-eye first image frame and a right-eye first image frame. In addition, the binocular image collection device may be used to acquire a left-eye second image frame and a right-eye second image frame. The electronic device may determine the landmark included in each image frame to be the third three-dimensional position if the landmark is included in each image frame collected through the binocular image collection device at a second collection time. In an example case in which the image collection device is the binocular image collection device, and the landmark is included in all image frames (e.g., the left-eye second image frame and the right-eye second image frame) collected by the binocular image collection device at the second collection time, the electronic device may determine the position of the landmark to be the third three-dimensional position of the second image frame and may determine the fifth uncertainty information corresponding to the third three-dimensional position. Referring to FIG. 4, after a position \hat{P}ᵢ² of the landmark of a dynamic object is moved to \hat{P}ᵢ₊₁², in an example case in which the landmark is observed in all second image frame I_{i+1,l} and second image frame I_{i+1,r}, the electronic device may determine a third three-dimensional position \hat{P}ᵢ₊₁ and fifth uncertainty D(\hat{P}ᵢ₊₁).

According to an embodiment, the electronic device may determine the third three-dimensional position by converting the position of the three-dimensional coordinate system of the landmark observed in the first image frame into the three-dimensional coordinate system of the second image frame, based on image data (e.g., the first image frame and the second image frame) acquired through the binocular image collection device at the second collection time.

The electronic device may determine whether the landmark is an outlier based on the second three-dimensional position, the third three-dimensional position, the fourth uncertainty information, and the fifth uncertainty information.

The electronic device may determine whether the landmark is an outlier based on the second three-dimensional position Pᵢ₊₁′, the third three-dimensional position \hat{P}ᵢ₊₁, the fourth uncertainty D(Pᵢ₊₁′), and the fifth uncertainty D(\hat{P}ᵢ₊₁).

According to an embodiment, the electronic device may determine sixth uncertainty information based on the fourth uncertainty information and the fifth uncertainty information. The electronic device may determine that the landmark is an outlier based on the difference between the second three-dimensional position and the third three-dimensional position satisfying a second condition based on the sixth uncertainty information. The electronic device may determine that the landmark is not an outlier based on the difference between the second three-dimensional position and the third three-dimensional position not satisfying the second condition. The second condition may include the difference between the second three-dimensional position and the third three-dimensional position exceeding a threshold error range for the sixth uncertainty information or the difference being greater than a threshold value of the third uncertainty information.

For example, the electronic device may determine the sixth uncertainty information by summing the fourth uncertainty D(Pᵢ₊₁′) and the fifth uncertainty D(\hat{P}ᵢ₊₁). According to an embodiment, the electronic device may determine the sixth uncertainty information by performing weight fusion on the fourth uncertainty D(Pᵢ₊₁′) and the fifth uncertainty D(\hat{P}ᵢ₊₁), but examples are not limited thereto.

The electronic device may determine the landmark P to be an outlier if a difference |Pᵢ₊₁′−\hat{P}ᵢ₊₁| is greater than a threshold value of sixth uncertainty |D(\hat{P}ᵢ₊₁)+D(Pᵢ₊₁′)| and may determine the landmark P to be not an outlier if not greater.

Referring to FIG. 4, in an example case in which two landmarks Pᵢ¹ and Pᵢ² are observed in the first image frame Iᵢ, Pᵢ¹ is a landmark in the background and Pᵢ² is a landmark on a dynamic object. However, the disclosure is not limited thereto, and as such, a number of landmarks may be different than two. The first three-dimensional positions corresponding respectively to the two landmarks Pᵢ¹ and Pᵢ² are \hat{P}ᵢ¹ and \hat{P}ᵢ², and the first uncertainty of the first three-dimensional positions may be determined. First uncertainty areas 411 and 412 may be areas corresponding to the first uncertainty information.

The positions where Pᵢ¹ and Pᵢ² are observed in the first image frame Iᵢ (including I_{i,l} and I_{i,r} of both eyes) may be pᵢ¹ (including p_{i,l}¹ and p_{i,r}¹ of both eyes) and pᵢ² (including p_{i,l}² and p_{i,r}² of both eyes), respectively. The second three-dimensional positions acquired by converting Pᵢ¹ and Pᵢ² into the three-dimensional coordinate system of the second image frame Iᵢ₊₁ may be Pᵢ₊₁¹ (including P_{i+1,r}¹ and P_{i+1,r}¹) and Pᵢ₊₁² (including P_{i+1,l}² and P_{i+1,r}²), respectively, and the electronic device may determine the third uncertainty information corresponding to the second three-dimensional positions. Third uncertainty areas 421 and 422 may be areas corresponding to the third uncertainty information.

In an example case in which the movement of a dynamic object causes the landmark Pᵢ² to be moved to Pᵢ₊₁², and if Pᵢ₊₁² is observed simultaneously in the second image frame I_{i+1,l} and the second image frame I_{i+1,r}, the electronic device may directly determine the third three-dimensional position corresponding to Pᵢ₊₁² to be \hat{P}ᵢ₊₁². Since Pᵢ¹ is the landmark in the background, the three-dimensional position may not be changed, and \hat{P}ᵢ₊₁¹≈\hat{P}ᵢ¹.

Pose data ξ in the second image frame Iᵢ₊₁ in a dynamic scene and the second uncertainty information of the pose data may be determined. A second uncertainty area 431 may be an area corresponding to the second uncertainty information.

The electronic device may determine whether the landmarks Pᵢ¹ and Pᵢ² are outliers on dynamic objects through the process above. For example, in an example case in which the landmark Pᵢ² is moved, the third three-dimensional position \hat{P}ᵢ₊₁² may be away from the second three-dimensional position Pᵢ₊₁²′. The electronic device may determine the landmark Pᵢ² to be an outlier if |Pᵢ₊₁²′−\hat{P}ᵢ₊₁²′| is greater than a threshold value of |D(\hat{P}ᵢ₊₁)+D(Pᵢ₊₁′)|.

If |Pᵢ₊₁¹′−\hat{P}ᵢ₊₁¹| is less than or equal to the threshold value of |D(\hat{P}ᵢ₊₁)+D(Pᵢ₊₁′), the electronic device may determine the landmark Pᵢ¹ to be not an outlier.

The electronic device may individually determine whether each landmark is an outlier in the dynamic scene. The electronic device may individually determine whether a landmark is an outlier based on the magnitude of uncertainty and the positional relationship of the landmark. Since the electronic device determines whether a landmark is an outlier not based on the whole image, the electronic device may also be useful even when dynamic objects occupy most of the image. In addition, in an example case in which a landmark is observed simultaneously from both eyes in the second image frame, the electronic device may also be useful in a situation (e.g., the case of FIG. 3) where the moving direction of a dynamic object is the same as a camera's moving direction by determining the three-dimensional position of the landmark and the uncertainty of the three-dimensional position.

In an example case in which a landmark is determined to be not an outlier, the electronic device may perform at least one among map reconstruction, the positioning of the electronic device, path planning, scene reconstruction, three-dimensional rendering, and three-dimensional reconstruction, based on the adjusting of the pose of the image collection device. In an example case in which the second image frame is a key frame, the electronic device may perform BA optimization by combining the determination results of each landmark.

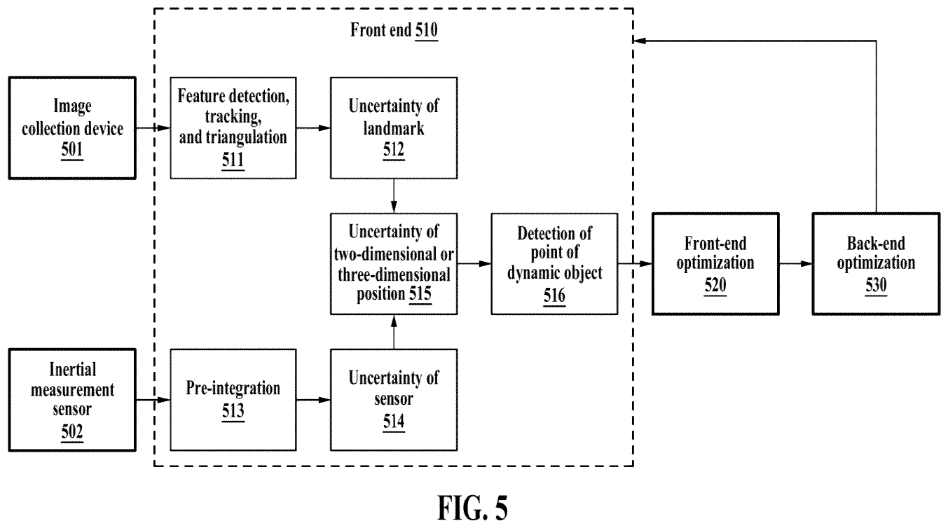

FIG. 5 is a block diagram illustrating a method of determining whether landmark is an outlier, according to an embodiment.

Referring to FIG. 5, an electronic device may acquire image data (e.g., an image frame) from a binocular image collection device 501 at a front end 510 and may receive sensor data from an inertial measurement sensor 502.

The electronic device may determine uncertainty information 512 of a landmark by performing feature detection, tracking, and triangulation 511 from the image data. For example, the electronic device may determine uncertainty information 512 for each of one or more landmarks by performing feature detection, tracking, and triangulation 511.

The electronic device may acquire sensor data (e.g., an inertial sensor-related noise parameter and sensor record data and the gyroscope deviation and acceleration deviation of a previous BA optimization output) and may determine the pose data of an image collection device and uncertainty information 514 of a sensor by performing pre-integration 513 on the sensor data. The electronic device may determine uncertainty information 515 of the two-dimensional or three-dimensional position of the landmark, based on the uncertainty information 512 of the landmark, the pose data of the image collection device, and the uncertainty information 514 of the sensor. Based on the uncertainty information 515 of the two-dimensional or three-dimensional position of the landmark, the electronic device may perform detection 516 of a point (e.g., the landmark) of a dynamic object and may determine whether the point of the dynamic object is an outlier. Based on the point to being an outlier, the electronic device may remove the outlier point and may perform front-end optimization 520 and back-end optimization 530. For example, based on a determination that the point is an outlier, the electronic device may remove the point that is an outlier and may perform front-end optimization 520 and back-end optimization 530. Back-end optimization 530 refers to improving feature detection, tracking, and triangulation 511 and pre-integration 513, and back-end optimization 530 refers to improving the accuracy of the electronic device's mapping, positioning, path planning, scene reconstruction, three-dimensional rendering, and three-dimensional reconstruction performance. The electronic device may repeatedly perform the operations above.

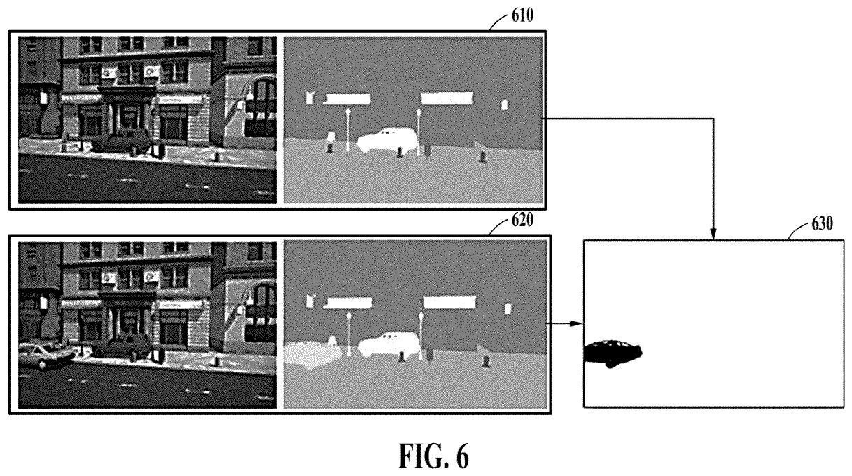

FIG. 6 is a diagram illustrating a method of generating a mask image of a dynamic object, according to an embodiment.

An electronic device that removes an outlier of a landmark based on two-dimensional and/or three-dimensional uncertainty may accurately and rapidly remove an outlier of the dynamic object, based on the uncertainty of three-dimensional position reconstruction, the uncertainty of the pre-integration of an IMU, uncertainty according to a camera coordinate system at different times, and uncertainty (e.g., projection) between a three-dimensional coordinate system and a two-dimensional coordinate system.

The electronic device may adaptively determine whether a landmark is an outlier based on the magnitude of uncertainty.

An electronic device may be implemented in an example scenario in which the dynamic object occupies most of the image, or in an example scenario the moving direction of the dynamic object is the same as or similar to the moving direction of a camera. Accordingly, the electronic device may improve the real-time performance, stability, efficiency, and reliability of VIO. The electronic device may not require the support of a graphics processing unit (GPU), and thus, computational resources may be saved.

The electronic device may be used in a smartphone, a tablet, a laptop, a smart wearable device (e.g., a wristwatch, glasses, etc.), a smart speaker, a vehicle-mounted terminal, a personal digital assistant, a portable multimedia player, a navigation device, a robot, a drone, or the like, and examples are not limited thereto. The electronic device may also be applied to a digital TV, a desktop computer, or other fixed terminals.

The electronic device may be applied to VIO processing in a server. For example, the electronic device may be used in a standalone physical server, a server cluster including multiple physical servers, or a distributed system. The electronic device may be applied to a cloud server that may provide a basic cloud computing service, such as a cloud service, a cloud database, cloud computing, a cloud function, cloud storage, a network service, cloud communication, a middleware service, a domain service, a security service, a content delivery network (CDN), big data, and an artificial intelligence platform. For example, the electronic device may be applied to a robot, a drone, autonomous driving, extended reality (XR), augmented reality (AR), virtual reality (VR), mixed reality (MR), or other fields.

The performance of the electronic device may be evaluated by the recall of inliers on background (RIB) and the recall of outliers on dynamic regions. The performance of the electronic device may be evaluated based on a visual-inertial odometry in dynamic environments (VIODE) dataset. The VIODE dataset may be a simulation dataset from which various data sequences are generated by adding the different numbers of dynamic objects to the same static scene. For ease of expression, a tracking time of a landmark may be defined as the number of feature points. In an example case in which the landmark is tracked twice, it may be defined that there are two feature points.

Referring to FIG. 6, the electronic device may generate a mask image 630 including only a dynamic object based on an image 610 and an image 620. The number of landmarks in the background is N_{Bg}^{all}, and the number of landmarks on a dynamic object is N_{Dy}^{all}. For example, the number of landmarks detected in the background and the number of landmarks detected on a dynamic object mask may be N_{Bg}^{IO} and N_{Dy}^{IO}, respectively. ROD and RIB may be determined respectively through Equations 15 and 16 below.

$$ROD = \frac{{N}_{Dy}^{IO}}{{N}_{Dy}^{all}} = \frac{{\sum }_{i = 1}^{N} {N}_{i , Dy}^{IO}}{{\sum }_{i = 1}^{N} {N}_{i , Dy}^{all}} \qquad [ Equation 15 ]$$

$$RIB = \frac{{N}_{Bg}^{all} - {N}_{Bg}^{IO}}{{N}_{Bg}^{all}} = \frac{{\sum }_{i = 1}^{N} ( {N}_{i , Bg}^{all} - {N}_{i , Bg}^{IO} )}{{\sum }_{i = 1}^{N} {N}_{i , Bg}^{all}} \qquad [ Equation 16 ]$$

In Equations 15 and 16, N denotes the number of image frames, N_{i,Bg}^{all} denotes the number of landmarks in the background and N_{Dy}^{all} denotes the number of landmarks on dynamic objects in an ith image frame, N_{i,Dy}^{IO} denotes the number of outliers detected in the background and N_{i,Bg}^{IO} denotes the number of outliers detected on the dynamic objects in the ith image frame. The performance of the electronic device may be evaluated based on the ROB and the RIB. The electronic device may reduce time and cost while maintaining similar accuracy compared to deep-learning-based SLAM.

FIG. 7 is a diagram illustrating an electronic device according to an embodiment.

Referring to FIG. 7, an electronic device 700 may include a processor 710, a transceiver 704, and a memory 703. However, the disclosure is not limited thereto, and as such, according to an embodiment, the electronic device may include one or more other components. The processor 710, the transceiver 704, and the memory 703 may be connected to one another via a bus 706. The electronic device 700 may correspond to the electronic device described above.

The transceiver 704 may be used to transmit the data of the electronic device 700 and/or receive the data, and there may be one or more transceivers 704.

The bus 706 may be used to relay the data among the processor 710, the transceiver 704, and the memory 703. The bus 706 may be a peripheral component interconnect (PCI) bus or an extended industry standard architecture (EISA) bus. The bus 706 may include an address bus, a data bus, a control bus, or the like.

The memory 703 may store instructions and a computer program 705 executable by the processor 701. The memory 703 may store the instructions executable by the processor 701. When executed by the processor 701, the instructions executable by the processor 701 may cause the processor 701 to perform an image processing method or a training method of a conversion model. The memory 703 may be integrated with the processor 701. For example, the memory 703, such as random-access memory (RAM) or flash memory, may be arranged in an integrated circuit microprocessor. In addition, the memory 703 may include a separate device, such as a storage device that may be used by an external disk drive, a storage array, or a database system. The memory 703 and the processor 701 may be operatively integrated or may allow the processor 701 to read a file stored in the memory 703 by communicating with each other via an input/output (I/O) port or a network connection. The memory 703 may be a non-transitory computer-readable storage medium that stores instructions and when the instructions are executed by the processor 701, the instructions stored in the memory 703 may prompt at least one processor 701 to execute the image processing method or an image processing model.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid-state drive (SSD), card memory (e.g., a multimedia card, a secure digital (SD) card, or an extreme digital (XD) card), magnetic tape, floppy disk, a magneto-optical data storage device, an optical data storage device, and other devices.

For example, the processor 701 may execute the instructions stored in the memory 703. The processor 701 may include a central processing unit (CPU), a GPU, a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof.

The processor 701, based on executing the instructions, may determine a first position corresponding to a position of a landmark in a first image frame acquired at a first collection time prior to a second collection time in a second image frame acquired at the second collection time, may determine uncertainty information representing a degree of uncertainty or reliability of the first position based on the determined first position, may determine the position of the landmark in the second image frame as a second position, and may determine whether the landmark is an outlier based on the determined first position, the determined second position, and the determined uncertainty information.

The processor 701 may determine the uncertainty information based on the error range of the first position and the reliability of the first position.

The processor 701 may determine a first three-dimensional position corresponding to a three-dimensional position of the landmark in the first image frame and first uncertainty information representing uncertainty of the first three-dimensional position, may determine pose data representing information on the pose of the image collection device at the second collection time and second uncertainty information representing uncertainty of the pose data, based on sensor data acquired from an inertial sensor during a time from the first collection time to the second collection time, may determine the first position corresponding to the position of the landmark in the first image frame in the second image frame, based on the first three-dimensional position and the pose data, and may determine uncertainty corresponding to the first position based on the first position, the first three-dimensional position, the pose data, the first uncertainty information, and the second uncertainty information.

The processor 701 may determine a projected position acquired by projecting the landmark in the first image frame onto the second image frame, may determine third uncertainty information representing uncertainty of the projected position based on the projected position, may determine a tracked position acquired by tracking the landmark in the second image frame, and may determine whether the landmark is an outlier based on the projected position, the tracked position, and the third uncertainty information.

The processor 701 may determine that the landmark is an outlier based on the difference between the projected position and the tracked position satisfying a first condition and may determine that the landmark is not an outlier based on the difference not satisfying the first condition. The first condition may include the difference exceeding a threshold error range for the third uncertainty information or being greater than a threshold value of the third uncertainty information.

In an example case in which the first position is a position corresponding to the landmark in the three-dimensional coordinate system, the processor 701, may determine a second three-dimensional position by converting the first three-dimensional position of the landmark in the first image frame into the three-dimensional coordinate system of the second image frame, may determine fourth uncertainty information representing uncertainty of the second three-dimensional position based on the second three-dimensional position, may determine a third three-dimensional position of the landmark in the second image frame, may determine fifth uncertainty information representing uncertainty of the third three-dimensional position based on the third three-dimensional position, and may determine whether the landmark is an outlier based on the second three-dimensional position, the third three-dimensional position, the fourth uncertainty information, and the fifth uncertainty information.

The processor 701 may determine sixth uncertainty information based on the fourth uncertainty information and the fifth uncertainty information, may determine that the landmark is an outlier based on the difference between the second three-dimensional position and the third three-dimensional position satisfying a second condition based on the sixth uncertainty information, and may determine that the landmark is not an outlier based on the difference not satisfying the second condition. The second condition may include the difference between the second three-dimensional position and the third three-dimensional position exceeding a threshold error range for the sixth uncertainty information or the difference being greater than a threshold value of the third uncertainty information.

The processor 701 may determine the landmark included in each image frame to be the third three-dimensional position based on the landmark being included in each image frame collected through the binocular image collection device at a second collection time.

The processor 701 may acquire a first result by determining whether the landmark is an outlier based on the first position, the second position, and the uncertainty information in the two-dimensional coordinate system, may acquire a second result by determining whether the landmark is an outlier based on the first position, the second position, and the uncertainty information in the three-dimensional coordinate system, and may determine that the landmark is an outlier based on the landmark being determined to be an outlier in at least one between the first result and the second result.

The processor 701 may determine the position of the landmark observed in the second image frame as the second position, based on data collected by a binocular image collection device at the second collection time or may determine the position of the landmark observed in the second image frame as the second position, based on data collected by the image collection device at the first collection time and the data collected by the image collection device at the second collection time.

In an example case in which the acquired map data includes the landmark, the processor 701, may determine the first three-dimensional position of the landmark included in the map data and may determine the first uncertainty information based on the first three-dimensional position of the landmark included in the map data, or may determine the first three-dimensional position corresponding to the three-dimensional position of the landmark observed in the first image frame and the first uncertainty information corresponding to the first three-dimensional position, based on data collected by a binocular image collection device at the first collection time.

The processor 701 may determine the pose data and the second uncertainty information at the second collection time by performing pre-integration based on at least one among a noise parameter of the inertial sensor, a gyroscope deviation of a previous BA optimization output, an acceleration deviation of the previous BA optimization output, and the sensor data.

In an example case in which the landmark is determined to be not an outlier based on the first position, the second position, and the uncertainty, the processor 701 may perform at least one among map reconstruction, the positioning of the electronic device, path planning, scene reconstruction, three-dimensional rendering, and three-dimensional reconstruction, based on the adjusting of the pose of the image collection device.

The blocks, modules or units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. An electronic device comprising:
a memory comprising at least one instruction; and
at least one processor configured to execute the at least one instruction,
wherein, when executed by the at least one processor, the at least one instruction is configured to control the electronic device to:
obtain a first position corresponding to a position of a landmark in a first image frame acquired at a first collection time prior to a second collection time in a second image frame acquired at the second collection time,
obtain uncertainty information corresponding to the first position based on the first position,
obtain a second position corresponding to the position of the landmark in the second image frame, and
determine whether the landmark is an outlier based on the first position, the second position, and the uncertainty information.

2. The electronic device of claim 1, wherein, when executed by the at least one processor, the at least one instruction is further configured to control the electronic device to:
determine the uncertainty information based on reliability for the first position or an error range of the first position,
wherein the first position comprises first position information corresponding to the landmark in a two-dimensional coordinate system and second position information corresponding to the landmark in a three-dimensional coordinate system.

3. The electronic device of claim 2, wherein the electronic device further comprises an image collection device, and
wherein, when executed by the at least one processor, the at least one instruction is configured to control the electronic device to:
obtain a first three-dimensional position corresponding to a three-dimensional position of the landmark in the first image frame and first uncertainty information corresponding to the first three-dimensional position,
obtain pose information corresponding to a pose of the image collection device at the second collection time and second uncertainty information representing corresponding to the pose information, based on sensor data acquired from an inertial sensor during a time from the first collection time to the second collection time,
obtain the second position corresponding to the position of the landmark in the second image frame, based on the first three-dimensional position and the pose information, and
determine the uncertainty information corresponding to the first position based on the first position, the first three-dimensional position, the pose information, the first uncertainty information, and the second uncertainty information.

4. The electronic device of claim 2, wherein, based on the first position being a position corresponding to the landmark in the two-dimensional coordinate system, the at least one instruction, when executed by the at least one processor, is further configured to control the electronic device to:
obtain a projected position by projecting the landmark in the first image frame onto the second image frame,
obtain third uncertainty information corresponding to the projected position based on the projected position,
obtain a tracked position by tracking the landmark in the second image frame as the second position, and
determine whether the landmark is an outlier based on the projected position, the tracked position, and the third uncertainty information.

5. The electronic device of claim 4, wherein, when executed by the at least one processor, the at least one instruction is further configured to control the electronic device to: determine that the landmark is an outlier based on a difference between the projected position and the tracked position satisfying a first condition, and
determine that the landmark is not an outlier based on the difference between the projected position and the tracked position not satisfying the first condition.

6. The electronic device of claim 5, wherein the first condition comprises:
the difference exceeding a threshold error range for the third uncertainty information or the difference being greater than a threshold value of the third uncertainty information.

7. The electronic device of claim 2, wherein, based on the first position being a position corresponding to the landmark in the three-dimensional coordinate system, the at least one instruction, when executed by the at least one processor, is further configured to control the electronic device to:
obtain a second three-dimensional position by converting a first three-dimensional position of the landmark in the first image frame into the three-dimensional coordinate system of the second image frame,
obtain fourth uncertainty information corresponding the second three-dimensional position based on the second three-dimensional position,
obtain a third three-dimensional position of the landmark in the second image frame,
obtain fifth uncertainty information corresponding to the third three-dimensional position based on the third three-dimensional position, and
determine whether the landmark is an outlier based on the second three-dimensional position, the third three-dimensional position, the fourth uncertainty information, and the fifth uncertainty information.

8. The electronic device of claim 7, wherein, when executed by the at least one processor, the at least one instruction is further configured to control the electronic device to:
obtain sixth uncertainty information based on the fourth uncertainty information and the fifth uncertainty information,
determine that the landmark is an outlier based on a difference between the second three-dimensional position and the third three-dimensional position satisfying a second condition based on the sixth uncertainty information, and
determine that the landmark is not an outlier based on the difference between the second three-dimensional position and the third three-dimensional position not satisfying the second condition.

9. The electronic device of claim 8, wherein the second condition comprises:
the difference exceeding a threshold error range for the sixth uncertainty information or the difference being greater than a threshold value of the sixth uncertainty information.

10. The electronic device of claim 7, wherein the electronic device further comprises a binocular image collection device, and
wherein the third three-dimensional position of the landmark in the second image frame is obtained based on the second image frame collected through the binocular image collection device at the second collection time.

11. The electronic device of claim 2, wherein, when executed by the at least one processor, the at least one instruction is further configured to control the electronic device to:
obtain a first result by determining whether the landmark is an outlier based on the first position, the second position, and the uncertainty information in the two-dimensional coordinate system,
obtain a second result by determining whether the landmark is an outlier based on the first position, the second position, and the uncertainty information in the three-dimensional coordinate system, and
determine that the landmark is an outlier based on the landmark being determined to be an outlier in at least one of the first result and the second result.

12. The electronic device of claim 2, wherein the electronic device further comprises an image collection device, and
wherein, when executed by the at least one processor, the at least one instruction is further configured to control the electronic device to:
obtain the position of the landmark in the second image frame as the second position, based on data collected by a binocular image collection device at the second collection time, or
obtain the position of the landmark in the second image frame as the second position, based on data collected by the image collection device at the first collection time and the data collected by the image collection device at the second collection time.

13. The electronic device of claim 3, wherein, when executed by the at least one processor, the at least one instruction is further configured to control the electronic device to:
obtain map data;
based on the map data comprising the landmark, determine the first three-dimensional position of the landmark comprised in the map data and determine the first uncertainty information based on the first three-dimensional position of the landmark comprised in the map data, or
determine the first three-dimensional position corresponding to the three-dimensional position of the landmark in the first image frame and the first uncertainty information corresponding to the first three-dimensional position, based on data collected by a binocular image collection device at the first collection time.

14. The electronic device of claim 3, wherein, when executed by the at least one processor, the at least one instruction is further configured to control the electronic device to:
determine the pose information and the second uncertainty information at the second collection time by performing pre-integration based on at least one of a noise parameter of the output, an acceleration deviation of the previous BA optimization output, and the sensor data.

15. The electronic device of claim 2, wherein the electronic device further comprises an image collection device, and
wherein, when executed by the at least one processor, the at least one instruction is further configured to control the electronic device to:
based on the landmark being determined to be not an outlier based on the first position, the second position, and the uncertainty information, perform at least one among map reconstruction, the positioning of the electronic device, path planning, scene reconstruction, three-dimensional rendering, and three-dimensional reconstruction, based on the adjusting of a pose of the image collection device.

16. A method executed by an electronic device, the method comprising:
obtaining a first position corresponding to a position of a landmark in a first image frame acquired at a first collection time prior to a second collection time in a second image frame acquired at the second collection time;
obtaining uncertainty information corresponding to the first position based on the first position;
obtain a second position corresponding to the position of the landmark in the second image frame; and
determining whether the landmark is an outlier based on the first position, the second position, and the uncertainty information.

17. The method of claim 16, wherein the obtaining the uncertainty information comprises:
determining the uncertainty information based on reliability for the first position or an error range of the first position,
wherein the first position comprises first position information corresponding to the landmark in a two-dimensional coordinate system and second position information corresponding to the landmark in a three-dimensional coordinate system.

18. The method of claim 16, wherein the determining the first position comprises:
obtaining a first three-dimensional position corresponding to a three-dimensional position of the landmark in the first image frame and first uncertainty information corresponding to the first three-dimensional position,
obtaining pose information representing information corresponding to a pose of an image collection device at the second collection time and second uncertainty information corresponding to the pose information, based on sensor data acquired from an inertial sensor during a time from the first collection time to the second collection time; and
obtaining the second position corresponding to the position of the landmark in the second image frame, based on the first three-dimensional position and the pose information, and
wherein the uncertainty information corresponding to the first position is obtained based on the first position, the first three-dimensional position, the pose information, the first uncertainty information, and the second uncertainty information.

19. The method of claim 17, wherein, based on the first position being a position corresponding to the landmark in the two-dimensional coordinate system,
the determining the first position comprises:
obtaining a projected position by projecting the landmark in the first image frame onto the second image frame,
the determining the uncertainty information comprises:
obtaining third uncertainty information corresponding to the projected position based on the projected position,
the determining the second position comprises:
determining a tracked position by tracking the landmark in the second image frame, and
the determining whether the landmark is an outlier comprises:
determining whether the landmark is an outlier based on the projected position, the tracked position, and the third uncertainty information.

20. The method of claim 17, wherein, based on the first position being a position corresponding to the landmark in the three-dimensional coordinate system,
the determining the first position comprises:
obtaining a second three-dimensional position by converting a first three-dimensional position of the landmark in the first image frame into the three-dimensional coordinate system of the second image frame,
the determining the second position comprises:
obtaining a third three-dimensional position of the landmark in the second image frame,
the determining the uncertainty information comprises:
obtaining fourth uncertainty information corresponding to the second three-dimensional position based on the second three-dimensional position,
determining fifth uncertainty information based on the third three-dimensional position, and
the determining whether the landmark is an outlier comprises:
determining whether the landmark is an outlier based on the second three-dimensional position, the third three-dimensional position, the fourth uncertainty, information and the fifth uncertainty information.
